(19) United States
(12) Patent Application Publication
(10) Pub. No.: US 2002/0040447 A1
(43) Pub. Date: Apr. 4, 2002

(54) Stable operating frequency detector and method for the same

(76) Inventors: Tsuei-Chi Yeh, Hsinchu (TW); Wen-Bin Liao, Hsinchu (TW)

Correspondence Address: J.C. PATENTS INC., 4 VENTURE, SUITE 250, IRVINE, CA, 92618, US

(21) Appl. No.: 09/788,704

(22) Filed: Feb. 20, 2001

(30) Foreign Application Priority Data
Oct. 4, 2000 (TW) 89120658

(51) Int. Cl. G06F 1/04; G06F 1/06; G06F 1/08

(52) U.S. Cl. 713/500

(57) ABSTRACT

An automatic stable frequency detector and a method of finding a stable operating frequency in a computer system. The detector includes a central processing unit, a monitoring timer and a clock generator for providing a clocking frequency to the computer system. The method is capable of saving much user labor for calibrating the operating frequency of the motherboard of a personal or notebook computer. This is because personal or notebook manufacturers can set up the computer system to work at the highest stable operating frequency of whatever computer system through software or hardware.

### CROSS-REFERENCE TO RELATED APPLICATION

This application claims the priority benefit of Taiwan application serial no. 89120658, filed Oct. 4, 2000.

### BACKGROUND OF THE INVENTION

1. Field of Invention

The present invention relates to a stable operating frequency detector in a computer system and the method for the same. More particularly, the present invention relates to a stable operating frequency detector and the method for the same capable of detecting a operating frequency to ensure a stable operation and a highest over frequency in a personal computer or notebook computer are obtained.

2. Description of Related Art

To operate a personal or notebook computer system, a plurality of clock pulse signals each having a definite function needs to be present on the motherboard of the computer system simultaneously. For example, a central processing unit (CPU) chip normally operates on a clocking frequency of 100 MHz, 300 MHz, 450 MHz or 500 MHz, a main memory unit normally operates at a clocking frequency of 66 MHz, 100 MHz or 133 MHz, and an input/output bus normally operates at a clocking frequency of 33 MHz.

Various clocking frequencies to a personal or notebook computer are normally produced by a clock generator. Clocking frequencies produced by a clock generator is transmitted to CPU, synchronous dynamic random access memory and peripheral component interconnect (PCI). The clocking frequencies must match the timing schedules of the chipset, the dynamic random access memory (DRAM) and the PCI device on the computer motherboard. In general, as long as the clocking frequency is within the timing schedule of a particular device, the personal or notebook computer can work properly.

Despite setting a normal operating frequency for each clock generator, clock generators are often used outside the normal operating frequency in order to increase the performance of personal or notebook computers. However, devices including CPU, chipset, DRAM module and PCI device are all limited by the operating frequency attained. When user attempts to adjust the frequency of the clock generator over the functional-system-board frequency or under the functional-system-board frequency, behavior of the operating system is difficult to predict. Without proper equipment, users are unable to adjust the clocking frequency of a clock generator according to the operating stability of the computer motherboard and obtain an optimum performance for a particular computer.

### SUMMARY OF THE INVENTION

Accordingly, one object of the present invention is to provide a device capable of detecting a stable operating frequency automatically so that much labor in calibrating the motherboard of a personal or notebook is saved. Hence, various computer manufacturers can program a computer motherboard through software or hardware and operate at the highest reachable over functional-system-board frequency possible according to component characteristics without incurring instability.

To achieve these and other advantages and in accordance with the purpose of the invention, as embodied and broadly described herein, the invention provides a method for automatically detecting a stable operating frequency in a computer system. The method includes reading out a preset clocking frequency. The preset clocking frequency is stored as a normal operation clocking frequency. The preset clocking frequency is next changed. The value in a monitoring timer is set before the timer starts counting. The timer is checked to determine whether the value in the timer has reached the end of counting. When the value in the monitoring timer has not yet reached the end of counting (indicating the system is not down), the clock frequency is stored as a normal operation clocking frequency. The clocking frequency is changed, the value in the monitoring timer is set, and the step of counting the value of the monitoring timer is continued. When the value in the monitoring timer has reached the end of counting, a reset signal is issued. On receiving the reset signal, the normal operation clock frequency is set to become the clocking frequency.

This invention also provides an automatic stable operating frequency detector that can be used in a computer system. The detector includes a central processing unit, a monitoring timer and a clock generator. The clock generator is coupled to the central processing unit for producing a clocking frequency to the computer system.

The central processing unit reads out a preset clocking frequency using a basic input/output system (BIOS). The clocking generator is set to the preset clocking frequency. The central processing unit stores the preset clocking frequency as a normal operation clocking frequency in a register. The central processing unit then changes the clocking frequency of the clock generator. The BIOS sets the value in a monitoring timer. The monitoring timer starts counting the value in the monitoring timer. When the monitoring timer has not reached to the preset value, the step of the central processing unit stores the clocking frequency as a normal operation frequency in a register. The central processing unit then changes the clocking frequency of the clock generator. The BIOS again sets the value in the monitoring timer. The monitoring timer continues to count. When the monitoring timer has counted to the preset value, the monitoring timer will issue a reset signal to the central processing unit. On receiving the reset signal, the central processing unit executes a reset routine to set the normal operation clock frequency as the clocking frequency of the clock generator.

The invention further provides an automatic stable operating frequency detector and the method for the same, which saves lots of manual labor required for detecting the optimum operating frequency for a personal or notebook computer. With this type of automatic frequency detector, running frequency of clock generator and motherboard can be increased or decreased without determining an operation stability of the motherboard by the user. Hence, most personal or notebook manufacturers are able to set the clocking frequency of a clock generator according to the operating stability and component characteristics of the motherboard, leading to an optimum performance for each type of computer.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram showing the hardware of an automatic stable operating frequency detector according to this invention;

FIG. 2A is a flow diagram showing the steps in raising the frequency of an automatic stable operating frequency detector according to this invention;

FIG. 2B is a flow diagram showing the steps in assessing the count in a monitoring timer of the automatic stable operating frequency detector according to this invention;

FIG. 2C is a flow diagram showing the steps in resetting the clocking frequency according to the automatic stable operating frequency detector of this invention; and

FIG. 3 is a flow diagram showing the steps for finding a stable operating frequency in a computer motherboard according to this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

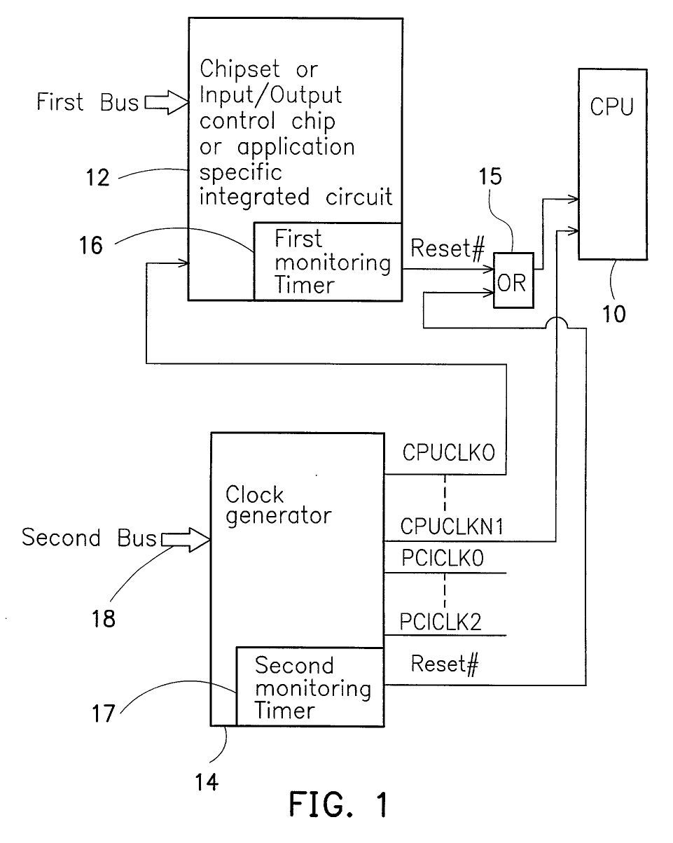

FIG. 1 is a block diagram showing the hardware of an automatic stable operating frequency detector according to this invention. As shown in FIG. 1, a computer system generally includes a central processing unit (CPU) 10, a chip 12 and a clock generator 14. The chip 12 can be a chipset, an input control chip or an application specific integrated circuit (ASIC), for example. The chip 12 includes a monitoring timer 1 16. The clock generator 14 may further include a monitoring timer 2 17. When the monitoring timer 1 16 has counted to zero, the monitoring timer 1 16 or the monitoring timer 2 17 will issue a reset # signal to an OR device 15. The OR device 15 then sends the reset # signal to the CPU 10 so that the CPU 10 can initiate a reset activity. The OR device 15 works by inputting a signal through any of its input end and outputting the signal through the output end of the OR device 15.

The CPU 10 reads out a preset clocking frequency from a basic input/output system (BIOS). The preset clocking frequency is transferred to a register (not shown) in the clock generator 14 via a system management bus (SM bus) or other bus (such as bus #2 18). The clock generator 14 generates a clocking frequency according to the value stored in the register.

The CPU 10 stores the preset clocking frequency as a normal operation frequency to a register (not shown) in the BIOS. The CPU 10 then changes the clocking frequency in the clock generator 14. The BIOS sets up the value inside the monitoring timer 1 16 and the monitoring timer 2 17 and starts counting. When the monitoring timers 1 16 and 2 17 have not reached the end of counting, the clocking frequency is stored as a normal operation frequency in the register of the BIOS. The CPU 10 then changes the clocking frequency in the clock generator 14. The BIOS again sets up the value inside the monitoring timer 1 16. The monitoring timers 1 16 and 2 17 continue the step of counting the value. And when the value of one of the monitoring timers 1 16 and 2 17 has reached the end of counting, the CPU 10 sets the normal operation clocking frequency as the clock frequency of the clock generator 14.

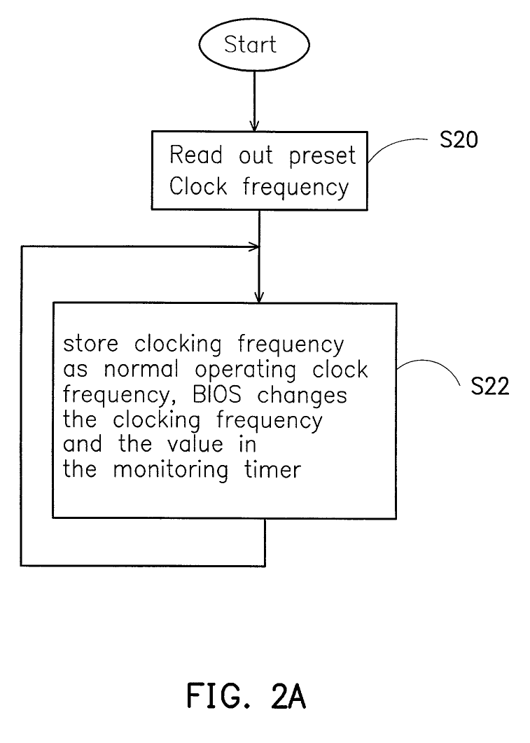

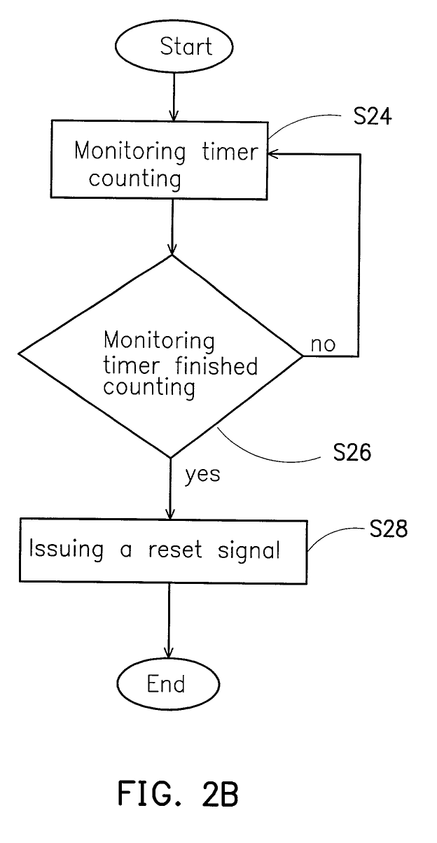

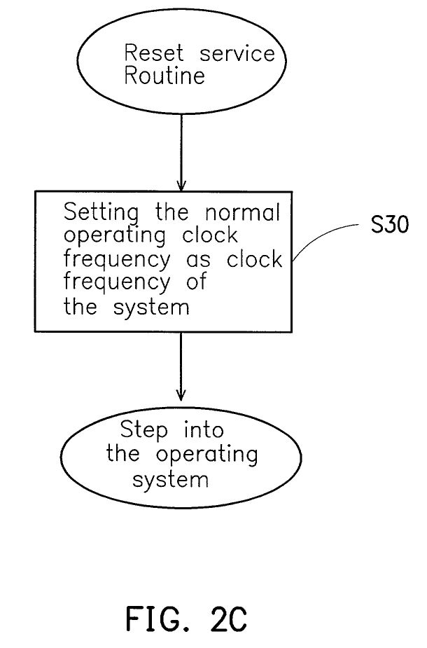

FIG. 2A is a flow diagram showing the steps in raising the frequency of an automatic stable operating frequency detector according to this invention. As shown in FIG. 2A, a CPU 10 reads out a preset clocking frequency from a BIOS (S20) and transfers to a clock generator. The CPU stores the preset clocking frequency as a normal operating frequency in a BIOS register. The CPU then changes the clocking frequency of the clock generator and the BIOS sets the value in a monitoring timer (S22).

FIG. 2B is a flow diagram showing the steps in assessing the count in a monitoring timer of the automatic stable operating frequency detector according to this invention. As shown in FIG. 2B, a monitoring timer starts counting after a BIOS sets the value inside the monitoring timer (S24). A CPU carried out various functions including system self-testing, chip setting and peripheral component searching. In the meantime, the monitoring timer determines whether the value inside the monitoring timer has reached an end value or not (S26). If the monitoring timer has not yet reached the end of counting, the program jumps back to the step of setting monitoring timer and initiates the counting again (S24). On the other hand, if the end of counting is reached, a reset signal is issued and sent to the CPU (S28).

FIG. 2C is a flow diagram showing the steps in resetting the clocking frequency according to the automatic stable operating frequency detector of this invention. As shown in FIG. 2C, a CPU receives a reset signal from a monitoring timer. The CPU next executes a reset routine and retrieves a normal operating frequency from a BIOS register. The clock generator is set such that the normal operating frequency becomes the clocking frequency of the clock generator (S30).

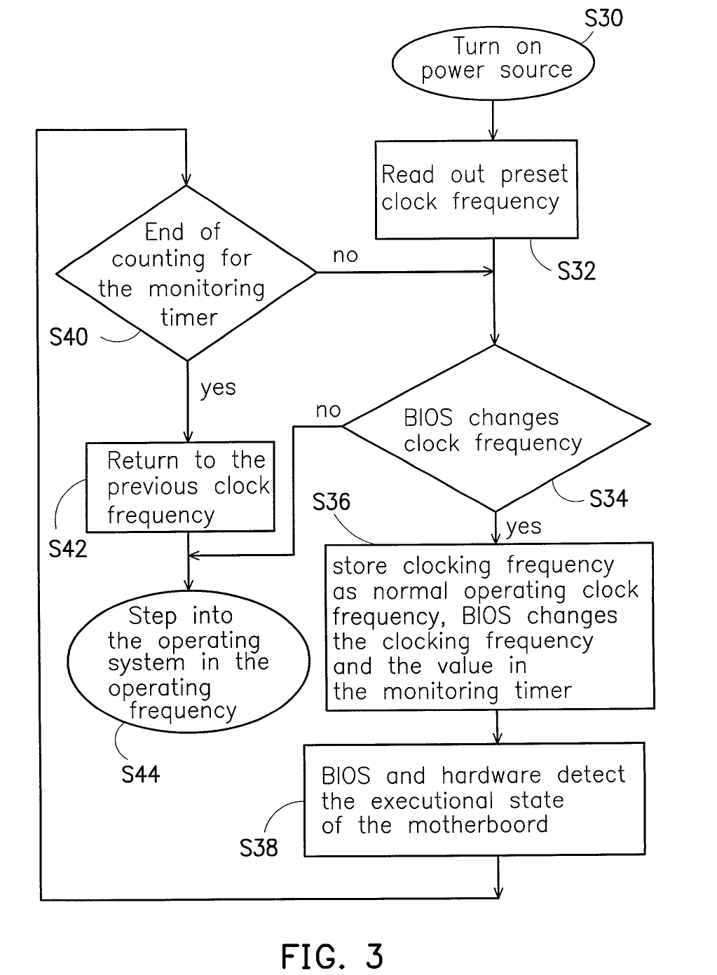

FIG. 3 is a flow diagram showing the steps for finding a stable operating frequency in a computer motherboard according to this invention. As shown in FIG. 3, power to a self-testing computer system is turned on (S30). The CPU in the computer system next reads out programs and system-preset values from BIOS. This includes the preset clocking frequencies of various computer system components (such as CPU, chipset, input/output control chip, ASIC and so on)(S32). The BIOS is checked to determine if any change to increase the clocking frequency in the computer system (changing the output clocking frequency of a clock generator) is required. If no change to the clocking frequency of the computer system is required, steps that initiate an operating system are executed. On the other hand, if the BIOS demands a change in the clocking frequency, the CPU stores up the existing clocking frequency as a normal operating frequency in a BIOS register or a CMOS memory unit. The BIOS transfers a new clocking frequency value to the clock generator register through a SM bus or other bus. The clock generator increases the clocking frequency to a level according to the new value. Meanwhile, the BIOS sets the value in a monitoring timer and starts registering the change in value inside the monitoring timer (S36).

After changing the clocking frequency generated by the clock generator, the BIOS, the chipset and other IC components on the computer motherboard work together. According to the programs in the BIOS, the CPU executes typical functions of a motherboard including system self-testing, chip setting and peripheral component searching (S38).

The end of counting in the monitoring timer (S40) implies the stabilization of operating frequency in the computer system. If the system remains stable after changing the operating frequency, the BIOS will trigger the CPU to set up a new value in the monitoring timer and continue to observe the changes in the monitoring timer. If system instability occurs after changing the operating frequency, the CPU will not reset the monitoring timer. Hence, counting in the monitoring timer is finished and a reset signal is issued. After receiving a reset signal, the CPU executes a reset routine. A normal operating frequency is retrieved from a BIOS register so that normal operating frequency of the system is set to the clocking frequency used by the clock generator (S42). After choosing a stable operating frequency, the computer operating system is initiated for executing user's programs.

If user wants to avoid the steps of detecting an optimum operating frequency, a command specifically asking not to change the clocking frequency of the clock generator self-testing can be preset into the BIOS beforehand. With such preset command in the BIOS, the computer system will get into the operating system without going through a clocking frequency search.

In summary, the automatic stable operating frequency detector of this invention saves lots of manual labor in finding the optimum operating frequency in a personal or notebook computer. With this type of automatic frequency detector, the operating frequency in a generator can be increased or decreased without determining the operation stability of the motherboard by the user. Hence, most personal or notebook manufacturers are able to set the clocking frequency of a clock generator according to the operating stability and component characteristics of the motherboard leading to optimum performance for each type of computer.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of detecting a stable operating frequency for a computer system, comprising the steps of:
setting an operation frequency of the computer system as a clocking frequency;
setting a value of the monitoring timer and initiating a counting step; and
setting the clocking frequency as a normal operating frequency when the value of the monitoring timer has not reached an end of the counting step.

2. The method of claim 1, wherein , further includes a step of detecting an execution state of the computer system after the counting step.

3. The method of claim 2, wherein the method further includes the sub-steps of:
determining whether to change the clocking frequency; and
executing steps of storing the clocking frequency as a normal operation clocking frequency, changing the clocking frequency, setting the value in the monitoring timer, and initializing the monitoring of the value in the monitoring timer when the clocking frequency is changed.

4. The method of claim 3, wherein the step of reading the preset clocking frequency is carried out after a step of turning on a main power source.

5. The method of claim 4, wherein after the step of setting the clocking frequency as a normal operation clocking frequency, a computer system with the set clocking frequency is initiated.

6. A method of detecting a stable operating frequency that can be applied to a computer system having a monitoring timer and a central processing unit, comprising the steps of:
the central processing unitreading a preset clocking frequency using the central processing unit and initiating the computer system for operating in the preset clocking frequency;
the central processing unitsetting the clocking frequency as a normal operation clocking frequency, changing the clocking frequency of the computer system, and changing a value in the monitoring timer;
the monitoring timer initiating a counting step;
the monitoring timer issuing a reset signal when the value of the monitoring timer has reached the end of the counting step; and
the central processing unit setting the clocking frequency of the computer system as the normal operation clocking frequency after receiving the reset signal.

7. The method of claim 6, further includes a step of detecting an execution state of the computer system when the central processing unit changing the clocking frequency of the computer system and changing the value of the monitoring timer.

8. An automatic stable frequency detector for a computer system, comprising:
a central processing unit;
a monitoring timer; and
a clock generator coupled to the central processing unit for providing a clocking signal to the computer system;
wherein the central processing unit reading a preset clocking frequency from a basic input/output system and setting the preset clocking frequency as the operating frequency of the clock generator, the central processing unit storing the clocking frequency as a normal operation clocking frequency and changing the clocking frequency of the clock generator, the basic input/output system setting a value in the monitoring timer, the monitoring timers initializing counting of the value, when the value in the monitoring timer has not reached the end of counting, the central processing unit storing the clocking frequency as a normal operation clocking frequency, changing the clocking frequency of the clock generator, and the basic input/output system setting the value in the monitoring timer and the monitoring timer continuing the initialization of the counting of the value, on the other hand, the monitoring timer sending a reset signal to the central processing unit, when the value in the monitoring timer has reached the end of counting, the central processing unit then executing a reset routine and setting the normal operation clocking frequency as the clocking frequency of the clock generator.

9. The detector of claim 8, further includes a chipset, an input/output control chip and an application specific integrated circuit, one of which includes a monitoring timer.
